(19) United States
(12) Patent Application Publication
(10) Pub. No.: US 2008/0238242 A1
(43) Pub. Date: Oct. 2, 2008

(54) DYNAMOELECTRIC MACHINE

(75) Inventors: Toshiyuki YOSHIZAWA, Chiyoda-ku (JP); Haruyuki Kometani, Chiyoda-ku (JP); Shinji Nishimura, Chiyoda-ku (JP); Masahiko Fujita, Chiyoda-ku (JP); Masaya Inoue, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 12/058,359

(22) Filed: Mar. 28, 2008

(30) Foreign Application Priority Data
Mar. 28, 2007 (JP) 2007-085291

(51) Int. Cl. H02K 1/12; H02K 1/24; H02K 1/02

(52) U.S. Cl. 310/216; 310/263; 310/254

(57) ABSTRACT

The dynamoelectric machine includes: a Lundell rotor that has: a pole core in which tapered claw-shaped magnetic pole portions are arranged in rows circumferentially so as to extend axially alternately from two axial ends and intermesh with each other; and a field coil that is mounted to the pole core; and a stator that has: a cylindrical stator core that surrounds the rotor so as to have a predetermined air gap; and a stator coil that is mounted to the stator core. The stator core is prepared by laminating and integrating dull finish magnetic steel plates, and a space factor of an iron portion in the stator core is in a range of 96 percent plus or minus 0.5 percent.

### BACKGROUND OF THE INVENTION

1. Field of the Invention

The present invention relates to a dynamoelectric machine such as an automotive alternator, etc., and particularly relates to a stator core construction that reduces overall loss in a dynamoelectric machine.

2. Description of the Related Art

Automotive alternators, which are one type of automotive dynamoelectric machine, are driven by transmitting rotational torque from an engine from a crank shaft to a pulley by means of a belt. As more and more devices in vehicles have become electrically driven in recent years, improvements in output and increased efficiency are being desired from alternators.

In order to aim for such increased efficiency, it has been proposed that magnetic steel plates that have a thin plate thickness are used for magnetic steel plates that are laminated into a stator core to reduce eddy current loss that arises inside the magnetic steel plates and reduce stator core loss (see Patent Literature 1, for example). Here, eddy current loss We in the magnetic steel plates can be expressed by Expression 1.

We=ke×t²×B²×f² (Expression 1)

where We is eddy current loss, ke is an eddy loss coefficient, t is the plate thickness of the magnetic steel plates, B is magnetic flux density, and f is the frequency of an alternating magnetic field.

Patent Literature 1: Japanese Patent Laid-Open No. 2001-25181 (Gazette)

In dynamoelectric machines such as automotive alternators, etc., dull finish cold-rolled steel plates are used for the magnetic steel plates that are laminated into the stator core from the viewpoint of cost and mass producibility. In dynamoelectric machines that have a Lundell rotor, complex three-dimensional magnetic circuits are formed in which magnetic flux also passes through in a direction of lamination of the magnetic steel plates, and eddy currents flow inside the surfaces of the magnetic steel plates, also giving rise to loss.

Now, gaps inevitably arise between the laminated magnetic steel plates as a result of laminating the magnetic steel plates. If dull finish magnetic steel plates that have a coarse surface roughness are used, gaps that result from that surface roughness also arise between the laminated magnetic steel plates. As described above, stator core loss can be reduced by making the plate thickness of the magnetic steel plates thinner. However, the thinner the plate thickness of the magnetic steel plates, the greater the number of laminated plates, increasing the total amount of gaps between the steel plates. Thus, the space factor of the magnetic steel plates, which can be expressed as {(the effective thickness of the iron portion/the thickness of the laminated body of magnetic steel plates)×100}, becomes smaller as the plate thickness of the magnetic steel plates becomes thinner.

In dynamoelectric machines that have a Lundell rotor, because complex three-dimensional magnetic circuits are formed in which magnetic flux also passes through in a direction of lamination of the magnetic steel plates, magnetic resistance increases in an axial direction if the space factor of the magnetic steel plates is reduced, reducing the overall amount of magnetic flux. In order to pass an equal amount of magnetic flux through the stator, it is necessary to increase the field current to the rotor by an amount proportionate to the reduction in the space factor of the magnetic steel plates. Increasing the field current leads to increased field loss in the rotor.

Thus, although making the plate thickness of the magnetic steel plates thinner can reduce eddy current loss (core loss) in the stator, the space factor of the magnetic steel plates is reduced and field loss in the rotor is increased, effectively increasing overall loss in the dynamoelectric machine.

### SUMMARY OF THE INVENTION

The present invention aims to solve the above problems and an object of the present invention is to provide a dynamoelectric machine that enables reductions in overall electrical loss that includes stator core loss, rotor field loss, and also other types of losses.

In order to achieve the above object, according to one aspect of the present invention, there is provided a dynamoelectric machine including: a Lundell rotor that has: a pole core in which tapered claw-shaped magnetic pole portions are arranged in rows circumferentially so as to extend axially alternately from two axial ends and intermesh with each other; and a field coil that is mounted to the pole core; and a stator that has: a cylindrical stator core that surrounds the Lundell rotor so as to have a predetermined air gap; and a stator coil that is mounted to the stator core. The stator core is prepared by laminating and integrating dull finish magnetic steel plates, and a space factor of an iron portion in the stator core is in a range of 96 percent plus or minus 0.5 percent.

According to the present invention, because the space factor of the iron portion in the stator core is in a range of 96 percent plus or minus 0.5 percent, overall electrical loss that is made up of stator core loss, rotor field loss, and other losses can be reduced. Because electrical loss is reduced, heat generation is suppressed, suppressing increases in copper loss, which depends on temperature. Because heat generation is suppressed, the volume of cooling air from fans that rotate together with the rotation of the rotor can also be reduced, enabling fan size to be reduced, and also enabling noise from the fans to be reduced.

### BRIEF DESCRIPTION OF THE DRAWINGS

FIG. 1 is a conceptual structural diagram of a winding field generator-motor according to Embodiment 1 of the present invention when applied to use in a vehicle;

FIG. 2 is a longitudinal section of the winding field generator-motor according to Embodiment 1 of the present invention;

FIG. 3 is a schematic diagram that explains a configuration of a stator core in the winding field generator-motor according to Embodiment 1 of the present invention;

FIG. 4 is a graph that shows a relationship between space factor of an iron portion of the stator core and plate thickness of magnetic steel plates in the winding field generator-motor according to Embodiment 1 of the present invention;

FIG. 5 is a graph that shows a relationship between the space factor of the iron portion of the stator core and field current in the winding field generator-motor according to Embodiment 1 of the present invention;

FIG. 6 is a graph that shows a relationship between the space factor of the iron portion of the stator core and losses in the winding field generator-motor according to Embodiment 1 of the present invention;

FIG. 7 is a graph that shows a relationship between the space factor of the iron portion of the stator core and overall loss in the winding field generator-motor according to Embodiment 1 of the present invention;

FIG. 8 is a front elevation of a magnetic steel plate in a stator manufacturing method according to Embodiment 2 of the present invention;

FIG. 9 is a perspective that shows a laminated state of magnetic steel plates in the stator manufacturing method according to Embodiment 2 of the present invention;

FIG. 10 is a perspective of a laminated core in the stator manufacturing method according to Embodiment 2 of the present invention; and

FIG. 11 is a diagram that explains a step of bending the laminated core in the stator manufacturing method according to Embodiment 2 of the present invention.

### DETAILED DESCRIPTION OF THE PREFERRED EMBODIMENTS

### Embodiment 1

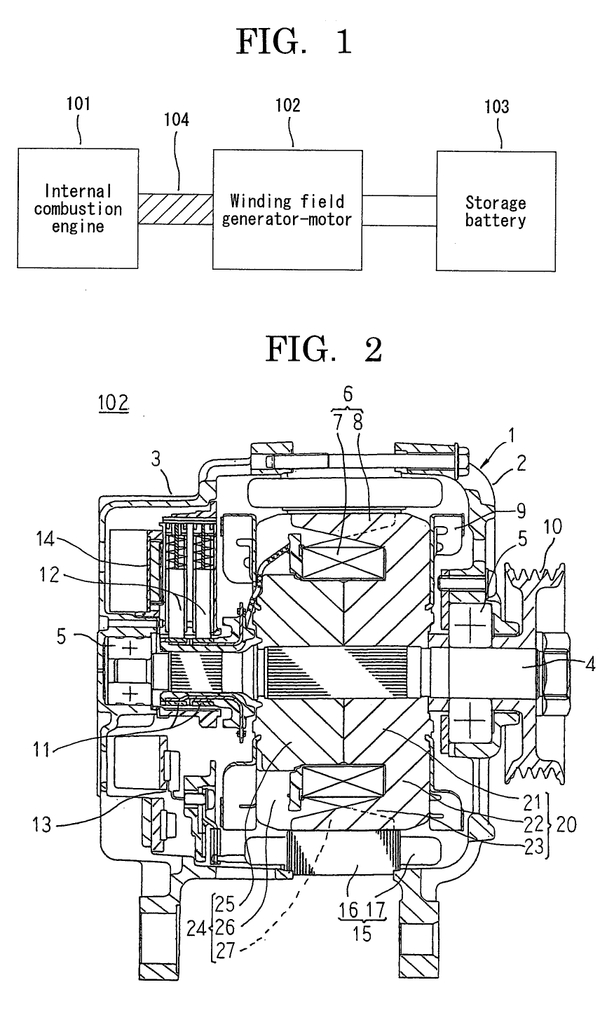

FIG. 1 is a conceptual structural diagram of a winding field generator-motor according to Embodiment 1 of the present invention when applied to use in a vehicle.

In FIG. 1, an internal combustion engine 101 is a gasoline engine, or a diesel engine, for example. A winding field generator-motor 102 that functions as a dynamoelectric machine is coupled to the internal combustion engine 101 directly, or is coupled by means of a coupling means 104 such as a belt, or a pulley, etc., and is disposed in a state that enables mutual transmission of torque. That is to say, when the internal combustion engine 101 is a driving source, torque from the internal combustion engine 101 is transmitted to the winding field generator-motor 102, and the winding field generator-motor 102 acts as a generator. When the winding field generator-motor 102 is the driving source, torque from the winding field generator-motor 102 is transmitted to the internal combustion engine 101 to start the internal combustion engine 101. The winding field generator-motor 102 is electrically connected to a storage battery 103. The storage battery 103 may be a storage battery that is shared with other automotive loads, or may also be a storage battery specifically for the winding field generator-motor 102.

FIG. 2 is a longitudinal section of the winding field generator-motor according to Embodiment 1 of the present invention.

In FIG. 2, the winding field generator-motor 102 includes: a case 1 that is constituted by a front bracket 2 and a rear bracket 3 that are each made of aluminum, that are formed so as to have an approximate cup shape, and that are disposed such that openings face each other; a rotor 6 that is rotatably disposed inside the case 1 such that a shaft 4 is supported by means of bearings 5 at a central axial position of the case 1; fans 9 that are fixed to two axial end surfaces of the rotor 6; a pulley 10 that is fixed to an end portion of the shaft 4 that projects outward at a front end of the case 1; a stator 15 that is fixed to the case 1 so as to surround an outer circumference of the rotor 6 so as to have a constant air gap relative to the rotor 6; a pair of slip rings 11 that are fixed to a rear end of the shaft 4, and that supply current to the rotor 6; a pair of brushes 12 that are disposed inside the case 1 so as to slide on the respective slip rings 11; a rectifier 13 that rectifies an alternating current that is generated in the stator 15 into direct current; and a voltage regulator 19 that adjusts magnitude of an alternating voltage generated in the stator 5.

The rotor 6 is a Lundell rotor, and includes: a field coil 7 that generates magnetic flux on passage of an excitation current; a pole core 3 that is disposed so as to cover the field coil 7 and in which magnetic poles are formed by that magnetic flux; and the shaft 4. The pole core 8 is fixed to the shaft 4, which is fitted through at a central axial position.

The pole core 8 is constructed so as to be divided into first and second pole core bodies 20 and 24 that are each prepared by a cold forging manufacturing method using a steel ingot that is constituted by a low carbon steel such as S10C, for example.

The first pole core body 20 has: a thick cylindrical first boss portion 21 through which a shaft insertion aperture is disposed at a central axial position; a thick ring-shaped first yoke portion 22 that is disposed so as to extend radially outward from a first end edge portion of the first boss portion 21; and first claw-shaped magnetic pole portions 23 that are disposed so as to extend toward a second axial end from outer circumferential portions of the first yoke portion 22. Eight first claw-shaped magnetic pole portions 23, for example, are formed so as to have a tapered shape in which a radially-outermost surface shape is an approximately trapezoidal shape, a circumferential width gradually becomes narrower toward a tip end, and a radial thickness gradually becomes thinner toward the tip end, and are arranged on the outer circumferential portions of the first yoke portion 22 at a uniform angular pitch circumferentially.

The second pole core body 24 has: a thick cylindrical second boss portion 25 through which a shaft insertion aperture is disposed at a central axial position; a thick ring-shaped second yoke portion 26 that is disposed so as to extend radially outward from a second end edge portion of the second boss portion 25; and second claw-shaped magnetic pole portions 27 that are disposed so as to project toward a first axial end from outer circumferential portions of the second yoke portion 26. Eight second claw-shaped magnetic pole portions 27, for example, are formed so as to have a tapered shape in which a radially-outermost surface shape is an approximately trapezoidal shape, a circumferential width gradually becomes narrower toward a tip end, and a radial thickness gradually becomes thinner toward the tip end, and are arranged on the outer circumferential portions of the second yoke portion 26 at a uniform angular pitch circumferentially.

The first and second pole core bodies 20 and 24 are fixed to the shaft 4, which is press-fitted into the shaft insertion apertures of the first and second boss portions 21 and 25 in a state in which the first and second claw-shaped magnetic pole portions 23 and 27 are made to face each other so as to intermesh with each other and end surfaces of the first and second boss portions 21 and 25 are abutted with each other. In a pole core 8 that is configured in this manner, the first and second claw-shaped magnetic pole portions 23 and 27 are arranged in a row so as to alternate circumferentially, radially-outermost surfaces of the first and second claw-shaped magnetic pole portions 23 and 27 correspond to a cylindrical surface that has a center of the shaft 4 as a central axis, and a uniform air gap is formed between the pole core 8 and an inner circumferential surface of the stator core 16.

The field coil 7 is configured by winding a conductor wire into many rows axially and many layers radially, and is mounted into a space that is bounded by the first and second boss portions 21 and 25, the first and second yoke portions 22 and 26, and the first and second claw-shaped magnetic pole portions 23 and 27.

The stator 15 includes: a cylindrical stator core 16; and a stator coil 17 that is installed in the stator core 16, and in which an alternating current arises due to changes in the magnetic flux from the field coil 7 that accompany rotation of the rotor 6.

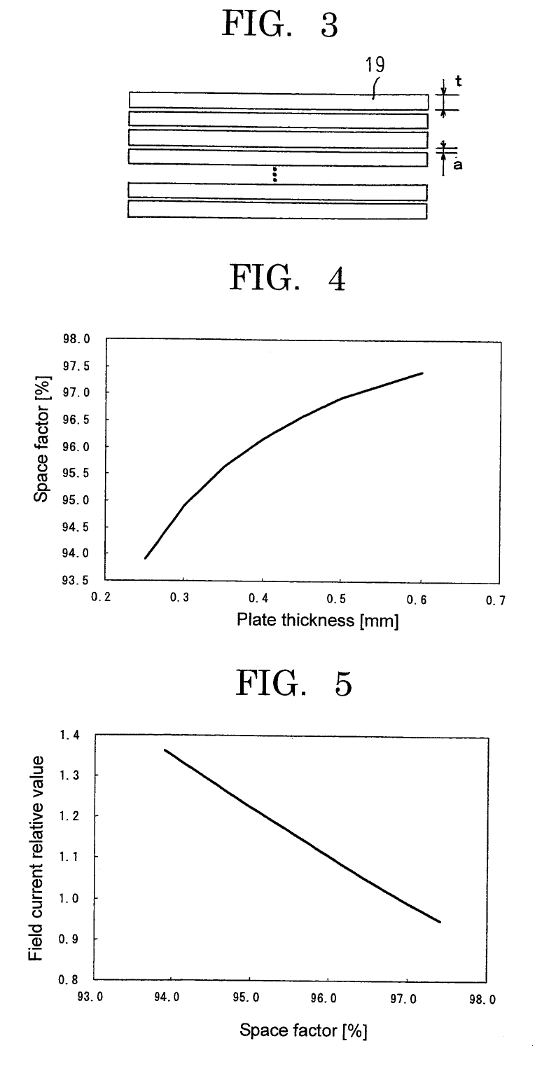

The stator core 16 is prepared by laminating and integrating a predetermined number of the magnetic steel plates 19 that have been obtained by press-forming dull finish cold-rolled steel plates into a predetermined shape. The magnetic steel plates 19 have a rough surface since they have a dull finish (roughness: 2 μm to 7 μm). Thus, the magnetic steel plates 19 cannot be laminated without gaps, and as shown in FIG. 3, gaps a are formed between the magnetic steel plates 19.

Now, measurements of space factor (%) of iron portions in stator cores 16 that have been prepared with various values of thickness t in the magnetic steel plates 19 are shown in FIG. 4. Moreover, the space factor (%) of the iron portion in the stator core 16 is the percentage of the substantive volume of the iron portion relative to the volume of the stator core (including the gaps between the magnetic steel plates), and in this case was expressed as {(the substantive thickness of the iron portion/the laminated height of the stator core)×100}. The space factor was calculated with the surface roughness of the magnetic steel plates 19 set at 4 μm, and the gaps a between the laminated magnetic steel plates 19 set at 8 μm.

It can be seen from FIG. 4 that if stator cores 16 that have a constant axial length are prepared, the number of laminated plates increases as the plate thickness t of the magnetic steel plates 19 becomes thinner, making the total amount of gaps between the laminated magnetic steel plates 19 larger and reducing the space factor, but the number of laminated plates decreases as the plate thickness t becomes thicker, making the total amount of gaps between the laminated magnetic steel plates 19 smaller and increasing the space factor.

Operation of a winding field generator-motor 102 that is configured in this manner will now be explained.

First, current is supplied from the storage battery 103 to the field coil 7 of the rotor 6 by means of the brushes 12 and the slip rings 11, generating magnetic flux. The first claw-shaped magnetic pole portions 23 of the first pole core body 20 are magnetized into North-seeking (N) poles by this magnetic flux, and the second claw-shaped magnetic pole portion 27 of the second pole core body 24 are magnetized into South-seeking (S) poles. At the same time, rotational torque from the internal combustion engine 101 is transmitted from an output shaft of the internal combustion engine to the shaft 4 by means of the belt and the pulley 10, rotating the rotor 6. Thus, a rotating magnetic field is applied to the stator coil 17 of the stator 15, generating electromotive forces in the stator coil 17. These alternating-current electromotive forces are rectified into direct current by the rectifier 13 to charge the storage battery 103 and to be supplied to electric loads, etc.

During starting of the internal combustion engine 101, alternating current is supplied sequentially to the stator coil 17, and a field current is supplied to the field coil 7 by means of the brushes 12 and the slip rings 11. Thus, the stator coil 17 and the field coil 7 become electromagnets, rotating the rotor 6 inside the stator 15 together with the shaft 4. The torque from the shaft 4 is transmitted from the pulley 10 to the output shaft of the internal combustion engine 101 by means of the belt, starting the internal combustion engine 101.

Because a complex three-dimensional magnetic circuit is formed in this winding field generator-motor 102, unlike general generator-motor stators, magnetic flux also flows axially through the stator 15. When the magnetic flux flows axially through the stator 15, if the space factor of the stator core 16 is small, magnetic resistance is increased, making it difficult for the magnetic flux to flow. Thus, if an identical field current is passed through the field coil 7, the smaller the space factor, the more reduced the amount of flux interlinked to the stator coil 17. Thus, in order to obtain an identical amount of interlinked magnetic force, it is necessary to increase the field current (field magnetomotive force).

Next, field current to obtain a constant amount of flux linked to the stator coil 17 was measured in generator-motors that used stators 15 that were prepared so as to vary space factor in the stator core 16, and the results thereof are shown in FIG. 5. Moreover, the field current value in a stator 15 that used a stator core 16 that was prepared such that the plate thickness t of the magnetic steel plates 19 was 0.50 mm, the surface roughness of the magnetic steel plates 19 was 4 μm, and the gaps a between the laminated magnetic steel plates 19 were 8 μm, and that had a space factor of 97 percent was taken as a reference value. In other words, the vertical axis represents relative values of field current where 1 is the field current at which a constant amount of flux linked to the stator coil 17 is obtained in a stator 15 that uses a stator core 16 that has a space factor of 97 percent.

It can be seen from FIG. 5 that the greater the space factor, the smaller the field current, and the smaller the space factor, the greater the field current. From the viewpoint of loss, if the field current is increased, the field core loss in the rotor 6 will increase. However, the smaller the space factor, the smaller the core loss in the stator 15, and the greater the space factor the greater the core loss.

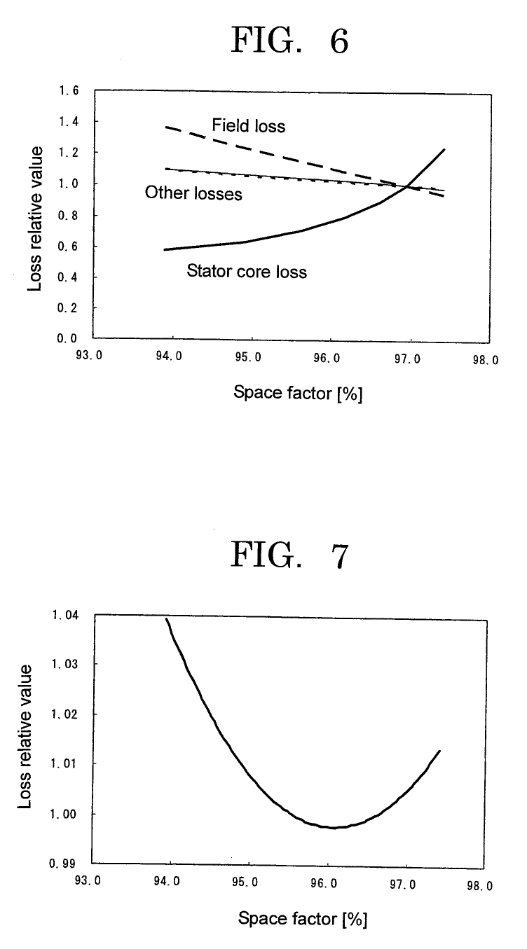

Next, stator core loss, rotor field loss, and other losses were measured in generator-motors that used stators 15 that were prepared so as to vary space factor in the stator core 16, and the results thereof are shown in FIG. 6. FIG. 7 shows a relationship between space factor in the stator core 16 and the total amount of the stator core loss, the rotor field loss, and other losses. Moreover, the losses in a generator-motor that used a stator 15 that had a stator core 16 that was prepared such that the plate thickness t of the magnetic steel plates 19 was 0.50 mm, the surface roughness of the magnetic steel plates 19 was 4 μm, and the gaps a between the laminated magnetic steel plates 19 were 8 μm, and that had a space factor of 97 percent were taken as reference values. In other words, the vertical axis represents relative values of loss where 1 is the stator core loss, rotor field loss, and other losses in the generator-motor that used a stator 15 that included a stator core 16 that had a space factor of 97 percent. The other losses are rotor core loss and stator copper loss.

It can be seen from FIG. 6 that the smaller the space factor, the smaller the stator core loss but the greater the rotor field loss, and the greater the space factor, the smaller the rotor field loss but the greater the stator core loss. Furthermore, changes in the other losses relative to the change in the space factor are small.

It can be seen from FIG. 7 that overall electrical loss in the generator-motor reaches a minimum value when the space factor is 96 percent, and that the overall loss can be reduced by setting the space factor to a range of 96 percent plus or minus 0.5 percent.

Thus, in a winding field generator-motor 102 that uses a stator core 16 that is prepared by laminating and integrating dull finish magnetic steel plates 19, overall electrical loss that is made up of stator core loss, rotor field loss, and other losses can be reduced by making the space factor of the iron portion in the stator core 16 96 percent plus or minus 0.5 percent.

A relationship between the plate thickness t of the magnetic steel plates 19 and the space factor of the iron portion in the stator core 16 will now be explained.

Making the surface roughness of the magnetic steel plates 19 coarser is conceivable as a means of reducing the space factor while maintaining increased plate thickness t. However, when magnetic steel plates 19 that have a coarse surface roughness are laminated, gaps between the laminated magnetic steel plates 19 are large, making them difficult to weld, and even if they are integrated by welding, coupling strength between the welded magnetic steel plates 19 is weak, giving rise to strength problems.

On the other hand, making the surface of the magnetic steel plates 19 smooth is conceivable as a means of increasing the space factor while maintaining reduced plate thickness t. However, making the surface of the magnetic steel plates 19 smooth requires applying a mirror finish to the dull finish cold-rolled steel plates, giving rise to cost increases. Reducing the gaps between the magnetic steel plates 19 and increasing the space factor by pressing the laminated body of magnetic steel plates 19 using a large pressing force is also conceivable, but it would be difficult to increase the pressing force on the laminated body of magnetic steel plates 19 beyond present capabilities.

Thus, it is difficult to limit the space factor to a range of 96 percent plus or minus 0.5 percent by adjusting the surface roughness of the magnetic steel plates 19 or the pressing force on the laminated body of magnetic steel plates 19 in this manner. However, limiting the space factor to a range of 96 percent plus or minus 0.5 percent by adjusting the plate thickness t of the magnetic steel plates 19 is effective from the viewpoints of cost, production, and characteristics. From FIG. 4, in order to prepare a stator core 16 in which the space factor is in a range of 96 percent plus or minus 0.5 percent simply, inexpensively, and with high joining strength, it is preferable to use magnetic steel plates 19 that have a plate thickness t of 0.37 mm to 0.48 mm, and it is particularly desirable to use magnetic steel plates 19 that have a plate thickness t of 0.4 mm.

### Embodiment 2

If internal strain arises in the magnetic steel plates 19 due to the cold rolling process and press molding, it becomes difficult for the magnetic flux to flow through the stator core 16 beyond that internal strain, bringing about deterioration in magnetic properties and increasing core loss. Embodiment 2 relates to a method for removing internal strain that would otherwise give rise to such deterioration in magnetic properties.

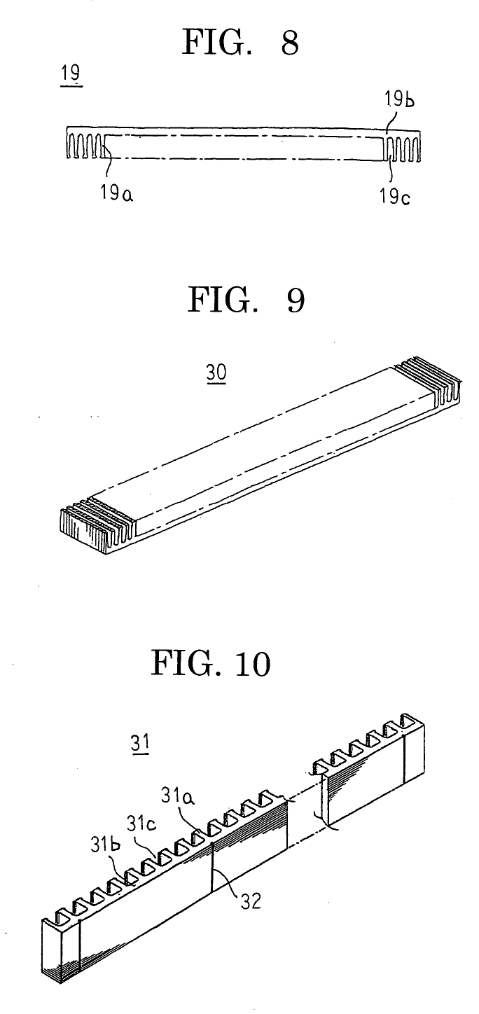

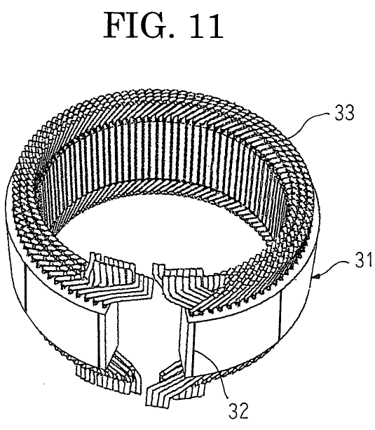

A stator manufacturing method and an internal strain removing method will be explained below with reference to FIGS. 8 through 11. Moreover, FIG. 8 is a front elevation of a magnetic steel plate in a stator manufacturing method according to Embodiment 2 of the present invention, FIG. 9 is a perspective that shows a laminated state of magnetic steel plates in the stator manufacturing method according to Embodiment 2 of the present invention, FIG. 10 is a perspective of a laminated core in the stator manufacturing method according to Embodiment 2 of the present invention, and FIG. 11 is a diagram that explains a step of bending the laminated core in the stator manufacturing method according to Embodiment 2 of the present invention.

First, magnetic steel plates 19 are prepared by press-forming a cold-rolled steel plate that has a dull finish. As shown in FIG. 8, these magnetic steel plates 19 are formed so as to have a flat, rectangular shape that has a length that is equal to a circumferential length of the stator core 16, and slot portions 19c that are defined by tooth portions 19a and a core back portion 19b are arranged longitudinally at a predetermined pitch.

A rectangular parallelepiped laminated body 30 is prepared by laminating a predetermined number of magnetic steel plates 19 that have been prepared in this manner with the tooth portions 19a, the core back portions 19b, and the slot portions 19c aligned and stacked as shown in FIG. 9. Next, a rectangular parallelepiped laminated core 31 is prepared by welding and integrating the core back portions 19b with each other while pressing the laminated body 30 in a direction of lamination using a predetermined pressing force. As shown in FIG. 10, this laminated core 31 has teeth 31a, a core back 31b, and slots 31c that are configured by stacking the tooth portions 19a, the core back portions 19b, and the slot portions 19c in the direction of lamination. A plurality of weld portions 32 that extend from a first end to a second end in the direction of lamination are formed at a predetermined pitch longitudinally.

Next, stator coil groups 33 are mounted into the respective slots 31c of the laminated core 31, and the laminated core 31 is bent into a cylindrical shape, as shown in FIG. 11. Then, a cylindrical stator core 16 is obtained by abutting end surfaces of the laminated core 31 that has been bent into a cylindrical shape, and integrating the abutted portion by welding. Next, a stator coil 17 is prepared by applying a wire connecting process to the stator coil groups 33.

A stator 15 is subsequently obtained by partially annealing an outer circumferential side of the stator core 16 to which the stator coil 17 has been mounted. The partial annealing can be performed by methods such as partial heating with a laser, or induction heating using a high-frequency power source to apply a high-frequency magnetic field through a yoke from outside, etc.

In Embodiment 2, because the stator 15 is prepared and the outer circumferential side of the stator core 16 is then partially annealed, internal strain that has arisen in the laminated core 31 due to bending it into a cylindrical shape is removed, enabling core loss in the stator 15 to be reduced.

Here, by using magnetic steel plates 19 that have a plate thickness that is greater than or equal to 0.37 mm and less than or equal to 0.48 mm, rigidity of the magnetic steel plates 19 themselves can be increased, and the magnetic steel plates 19 are also joined to each other firmly by the weld portions 32 that are applied to the core back 31b of the laminated core 31. Thus, the laminated magnetic steel plates 19 in the laminated core 31 can be prevented from coming apart, and the magnetic steel plates 19 can be prevented from wrinkling, etc., in the process of bending of the laminated core 31, making it unnecessary to dispose thick end plates on two ends of the laminated core 31. Thus, the stator core 16 can be prepared using only one kind of magnetic steel plate 19, eliminating a necessity to prepare steel plates that have different thicknesses, thereby shortening preparation processes and also enabling costs to be reduced. If end plates that have a thick plate thickness are disposed on axial ends of a stator core, eddy current loss in the end plates is increased, but here eddy current loss can be reduced proportionately by not using end plates that have a thick plate thickness.

### Embodiment 3

In Embodiment 2 above, the stator 15 is prepared and then the outer circumferential side of the stator core 16 is partially annealed, but in Embodiment 3, magnetic steel plates that have been prepared by press-forming dull finish cold-rolled steel plates into a predetermined shape are annealed in an inert gas atmosphere such as argon, nitrogen, etc., or in a vacuum.

In Embodiment 3, because internal strain that has arisen in the magnetic steel plates due to the cold rolling process and the press-forming process is also removed, core loss is reduced in the stator, enabling overall loss to be further reduced.

Moreover, in Embodiment 3 above, an annealing treatment is applied after the magnetic steel plates have been press-formed, but an annealing treatment may also be applied to the whole stator after the stator has been prepared.

In Embodiments 2 and 3 above, stator cores are prepared by laminating magnetic steel plates that have been obtained by press-forming a dull finish cold-rolled steel plate into flat, rectangular shapes, and bending that laminated body into a cylindrical shape, but a stator core may also be prepared by laminating and integrating magnetic steel plates that have been obtained by press-forming a dull finish cold-rolled steel plate into flat, annular shapes. In that case, an annealing treatment may be applied to the magnetic steel plates, to the stator core, or to the stator. A stator core may also be prepared by laminating into a helical shape and integrating a magnetic steel plate that has been obtained by press-forming a dull finish cold-rolled steel plate into a strip shape. In that case, an annealing treatment may be applied to the stator core, or to the stator.

In each of the above embodiments, magnetic steel plates to which a resin coating has not been applied are used, but magnetic steel plates to which a resin coating has been applied may also be used. In that case, allowance should be made for the resin coating layer that has been coated onto the magnetic steel plates when setting the space factor of the iron portions in the stator core to a range from 96 percent plus or minus 0.5 percent.

In each of the above embodiments, the present invention is explained as it applies to automotive generator-motors, but the present invention is not limited to generator-motors provided that a Lundell rotor is mounted, and similar effects are also exhibited if the present invention is applied to other dynamoelectric machines such as electric motors, or alternators, for example.

What is claimed is:

1. A dynamoelectric machine comprising:
a Lundell rotor comprising:
a pole core in which tapered claw-shaped magnetic pole portions are arranged in rows circumferentially so as to extend axially alternately from two axial ends and intermesh with each other; and
a field coil that is mounted to said pole core; and
a stator comprising:
a cylindrical stator core that surrounds said Lundell rotor so as to have a predetermined air gap; and
a stator coil that is mounted to said stator core,
wherein said stator core is prepared by laminating and integrating dull finish magnetic steel plates, and a space factor of an iron portion in said stator core is in a range of 96 percent plus or minus 0.5 percent.

2. A dynamoelectric machine according to claim 1, wherein a plate thickness of said magnetic steel plate is greater than or equal to 0.37 mm and less than or equal to 0.48 mm.

3. A dynamoelectric machine according to claim 2, wherein said stator core is prepared by laminating and integrating only magnetic steel plates that have an identical plate thickness.

4. A dynamoelectric machine according to claim 1, wherein said stator core is prepared by laminating and integrating said magnetic steel plates that have been annealed.

5. A dynamoelectric machine according to claim 1, wherein an annealing treatment is performed on said stator core after said magnetic steel plates have been laminated and integrated.

6. A dynamoelectric machine according to claim 1, wherein an annealing treatment is performed on said stator in a state in which said stator coil is mounted to said stator core.
